(19) United States
(12) Patent Application Publication
(10) Pub. No.: US 2022/0391328 A1
(43) Pub. Date: Dec. 8, 2022

(54) CONTINUOUS DATA PROTECTION IN CLOUD USING STREAMS

(71) Applicant: EMC IP Holding Company LLC, Hopkinton, MA (US)

(72) Inventors: Valerie Lotosh, Ramat Gan (IL); Erez Sharvit, Ramat Gan (IL); Jehuda Shemer, Kfar Saba (IL)

(21) Appl. No.: 17/303,608

(22) Filed: Jun. 3, 2021

(51) Int. Cl. G06F 12/14; G06F 11/14

(52) U.S. Cl. CPC G06F 12/1425; G06F 11/1446; G06F 2212/1052; G06F 2201/84

(57) ABSTRACT

One example method includes performing a recovery operation. A recovery operation is performed using streams rather than volumes in the cloud and without using compute instances or servers for do data. Do data is written to a do stream. Occasionally, a compute instance power on reads data from the do stream. The do data ready from the do stream is applied to a cloud volume and a snapshot of the cloud volume is performed. The backups include discrete PiT backups and recovery can be performed to any of the discrete PiT backups.

### FIELD OF THE INVENTION

Embodiments of the present invention generally relate to computing operations including data protection operations. More particularly, at least some embodiments of the invention relate to systems, hardware, software, computer-readable media, and/or methods for continuous data protection operations in the cloud.

### BACKGROUND

Data protection systems are generally configured to protect production data. However, production data may become unavailable for many reasons (e.g., corruption, disaster, user error, malicious actions). Production data can be protected by generating backups. By generating backups, the data protection system can restore the production data from a backup in the event that production data is unavailable.

There are many ways to perform backup operations. Periodic backups, for example, allow production data to be restored to specific points in time corresponding the available backups. Some data protection systems provide PiT (Point-in-Time) backups. PiT backups allow production data to be restored to any supported point in time.

PiT backups are generally achieved using journals. A journal is used to store the data that is new and to store the data that is being replaced. Journals are an integral participant in generating PiT backups and ensure that data can be restored to any supported PiT.

However, journals are implemented in cloud volumes (e.g., AWS EBS volume) and, as a results, require compute power (e.g., a compute instance or virtual server (EC2 instance)). The need for compute power increases the cost of the backups. Further, it is often necessary to determine and/or adjust the capacity for the journals, particularly when the backup load changes.

More specifically, managing cloud volumes (e.g., EBS (Elastic Block Store) volumes) and adjusting quickly to changes in production workloads is complex. Further, EBS volumes can be expensive and may have a predefined volume size regardless of changes in retention. The high cost may lead entities to compromise on the protection, which may result in fewer PiTs and higher RTO (Recovery Time Objective) times. These factors result in high cost.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of performing data protection operations using a journal;

FIG. 2 discloses aspects of performing data protection operations without using a journal;

FIG. 3A discloses aspects of performing a data protection including PiT backup and recovery operations using streams;

FIG. 3B discloses aspects of performing PiT backup and recovery operations using streams;

FIG. 4A discloses aspects of performing data protection operations in the cloud;

FIG. 4B discloses aspects of performing PiT backup and recovery operations using streams;

FIG. 5A discloses aspects of chunk-based PiT backups using streams; and

FIG. 5B discloses aspects of chunk-based backup and/or recovery operations.

### DETAILED DESCRIPTION OF SOME EXAMPLE EMBODIMENTS

Embodiments of the present invention generally relate to computing operations including data protection operations. More particularly, at least some embodiments of the invention relate to systems, hardware, software, computer-readable media, and methods for data protection operations including backup operations, streaming operations, PiT (Point-in-Time) operations, and the like or combination thereof. Embodiments of the invention further relate to on-site and/or cloud-based operations. Embodiments of the invention further relate to operations performed on the replica or target site.

PiT operations are performed in or by data protection systems. These operations include sending data to the cloud, generating PiT backups, and performing restore or recovery operations using the PiT backups. When generating backups such as PiT backups, IOs (e.g., writes or write data) that occur in a production system or source are copies or replicated to a target or replica site. The target or replica site may be cloud-based and data replicated to the cloud may be stored in cloud object storage such as available in AWS, Azure, or the like.

To achieve any PiT backups, the IOs stored in the cloud may be stored as Do data and Undo data. Do data is the data received from the source and is coming from hosts, splitters, data protection appliances, or the like. For example, the IOs generated by virtual machines that are written to virtual disks are examples of data that becomes Do data when transmitted to the cloud. Undo data is data that was present on a device (e.g., a cloud volume) prior to being overwritten with new or Do data. In other words, the Undo data represents Do data that was previously stored in the cloud.

Saving the Undo data allows a backup to be rolled forward or backward to a specific point in time. Thus, any supported PiT can be recovered. Embodiments of the invention carefully manage the Do data and the Undo data and ensure that the correct locations and sequence of the Do data and the Undo data are preserved.

Embodiments of the invention are discussed with respect to logical volumes or virtual disks, which are associated with virtual machines. Thus, production logical volumes or virtual disks are replicated to a replica site and stored, in one example, in cloud-based volumes. Embodiments of the invention can be used with multiple virtual machines, multiple volumes, multiple consistency groups (e.g., groups of volumes backed up together), or other volumes or drives including physical volumes. Further, embodiments of the invention are scalable.

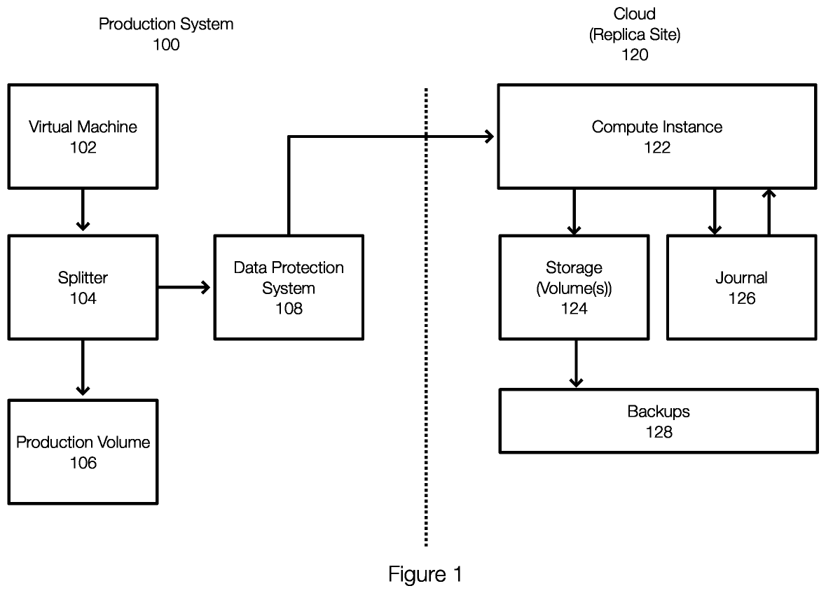

FIG. 1 discloses aspects of continuous data protection from a production system or site to a target or replica site, which may be in the cloud (e.g., datacenters). The production system 100 may include multiple physical and/or virtual machines, applications, and the like. The production system 100 may also include hardware including processors, memory, networking equipment, and the like.

FIG. 1 illustrates a virtual machine 102 that is associated with a production volume 106 (a logical volume or virtual disk such as a VMDK file) that is part of a larger production storage. The production storage may include physical disks/volumes and virtual disks/volumes of other virtual machines.

The cloud 120 may be configured to implement a replica site or target site. The target or destination of IOs processed by the data protection system 108 is the target site in the cloud 120.

IOs from the virtual machine 102 to the production volume 106 may be intercepted by a splitter 104, which may be associated with or part of a data protection system 108. The splitter 104 may send the write or a copy thereof to the data protection system 108. Upon receiving an acknowledgement from the data protection system 108 that the IO or write has been received, the write is then sent to the production volume 106.

The data protection system 108 (e.g., DELL EMC RecoverPoint) may be a physical/virtual appliance and/or may be implemented using physical and/or virtual machines. The data protection system 108 may also be containers or other compute devices or entities. Writes received at the data protection system 108 from the splitter 104 are processed (e.g., deduplicated, encrypted, batched) and transmitted to the cloud 120. The writes are written to a volume 124 in the cloud 120, which is a replica of the production volume 106 in this example. In one example, this allows virtual machines in a production system to be protected in the cloud and allows for disaster recovery, failover, and the like.

The production volume 106 is an example of storage used by a virtual machine. The virtual machine 102 may be associated with one or more virtual disks and or one or more logical volumes. An application may be associated with one or more virtual machines and one or more virtual volumes.

More generally, the data protection system 108 receives or copies IOs occurring in the production system 100, processes the IOs, and sends the IOs or writes to a compute instance 122 (e.g., a server) in the cloud 120. The compute instance 122 writes the IOs as Do data in a journal 126 that is implemented as a volume. The compute instance 122 then reads the IO from the journal 126 and writes the IO to the storage 124. The storage 124 may be a disaster recovery volume that corresponds to the production volume 106. More specifically, the storage 124 may be a virtual disk or volume that corresponds to the virtual disk or volume 106 of the virtual machine 102 in the storage 106. A snapshot or other backup 128 may be generated from the storage 124 (e.g., a snapshot of the virtual volume or disk in the storage 124).

Because using journaling for the Do data and the Undo data can be inefficient and costly, embodiments of the invention enable PiT in the cloud without using volumes. Embodiments of the invention provide continuous protection to the cloud. Some embodiments of the invention, however, provide protection without using volumes for the Do data and the Undo data. More specifically, at least some embodiments of the invention use streams to store incoming IOs to facilitate any PiT snapshots on cloud without using volumes for journaling.

Embodiments of the invention implement data protection operations using streams. In one example, a stream is an example of a First in First Out (FIFO) queue. A stream may provide dynamic allocation and service levels. In the cloud, streams or queueing services can be optimized for various service levels (e.g., cost, availability, performance). In one example, a stream may support persistency (data inserted in the queue is guaranteed to survive queue failures). A stream may also need to have the ability to scale out to support higher performance. Scale out and load balancing may be provided by the queue. Examples of streams or queues include Kafka, RabbitMZ, ActiveMQ and Pravega streams.

Embodiments of the invention may operate in the context of protecting volumes or consistency groups (e.g., a group of volumes or virtual machines that are protected together). When performing or initializing data protection operations, copies of the production volumes are created at the protection site or in the cloud. Thus, the data protection operations often establish an image of the production volumes and operations may start after the replica site has an image of the production data. Thus, embodiments of the invention my initialize the process by ensuring that a full image of the production volume (or volumes in a consistency group) are available at the cloud. The process of replicating IOs at the production site to the cloud may then begin and PiT backups may be generated starting from the time associated with the initial full image.

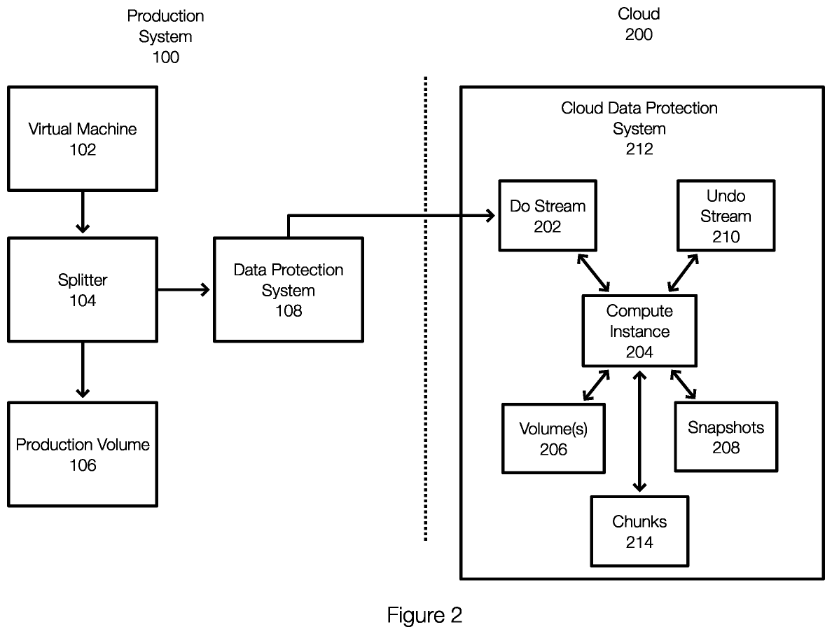

FIG. 2 illustrates an example configuration of a data protection system at a source side and a cloud data protection system at the replica or target. The cloud data protection system 212 may be part of the data protection system 108 or may be separate from the data protection system 108. The cloud data protection system 212 is configured to operate, in this example in the cloud 200 or in the replica site. The production system 100 has been previously described.

Generally, the data protection system 108, for each protected virtual machine or for each consistency group, creates a do stream 202 in the cloud 200. Data for different do streams may be transmitted at the same time. The do stream 202 is thus configured to store do data received from or replicated from the production system 100. The data protection system 108 is also aware of the state of consistency of the data. For example, the data protection system 108 is aware of whether all IOs are accounted for and of whether the IOs are in the correct order. The data protection system 108 may also be aware of an application consistency state.

As a result, the data protection system 108 can insert information (e.g., a marker) into the do stream 202 that identifies when the do stream is consistent and when snapshots can be taken. A marker may be inserted for certain PiTs. Alternatively, markers that provide information about consistency start/end may be provided or included in the do data stored in the do stream 202. This allows any point in time to be used by the backend system in the cloud. In one example, the PiT information may be placed in a separate stream and may include references to the IO stream index/timestamp in order to determine the location of consistency points.

The cloud data protection system 212 may include various components. Embodiments of the invention may use one or more of the components. In one example, the do stream 202 received IOs or writes from the data protection system. A compute instance 204 is responsible for reading the do stream 202 and writing the data read from the do stream 202 to volume(s) 206. In one example, the volume(s) 206 include a volume for each production volume being replicated. The volumes 206 may be configured similarly to their production system 100 counterpart. If each volume has its own do stream, then the compute instance 204 (or multiple compute instances) operate to write data in the do stream 202 to the corresponding volumes 206.

The cloud data protection system 212 may also include an undo stream 210 in some embodiments. When committing writes from the do stream 202 to the volumes 206, data being overwritten may be stored in the undo stream 210. The undo stream 210 may maintain information about when the writes occurred, the order in which writes occurred, and the like. In other words, the undo stream 210 is configured such that the volumes 206 can be recovered to any supported PiT. When data is deleted from the undo stream 210, the ability to recover PiTs from those points in time corresponding to the deleted entries or data are removed.

The snapshots 208 may be snapshots of the volumes 206. Snapshots 208 are taken, by way of example, for testing purposes, or as specific PiT backups. For example, during recovery, the volume 206 is restored. A snapshot may be taken such that the volume can be recovered in the event that testing the restored volume fails.

Chunks 214 may be stored in cloud object storage and represent an embodiment where the backups or snapshots include chunks and/or a portion of an undo stream. Embodiments of the invention may have one or more of the components in the cloud data protection system 212 and embodiments may have different combinations thereof.

Once initialized, the IOs from the data protection system 108 are received into a do stream 202 in the cloud 200. Occasionally (e.g., periodically, on command, in response to an event (do stream and/or undo stream reaches a predetermined size)), a compute instance 204 will power on and read the IOs or data in the do stream 202. The IOs may be read up to a certain point, such as a consistency point, until the do stream size is below a threshold, or the like. The IOs read from the do stream 202 are then applied to the volume 206. Snapshots may be taken of the volume 206. As described in more detail below, embodiments may or may not have an undo stream.

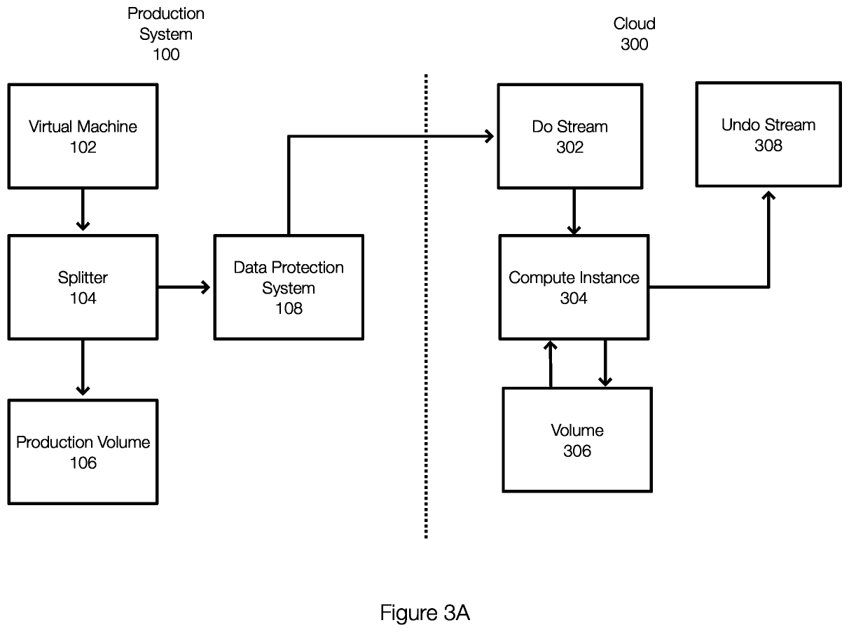

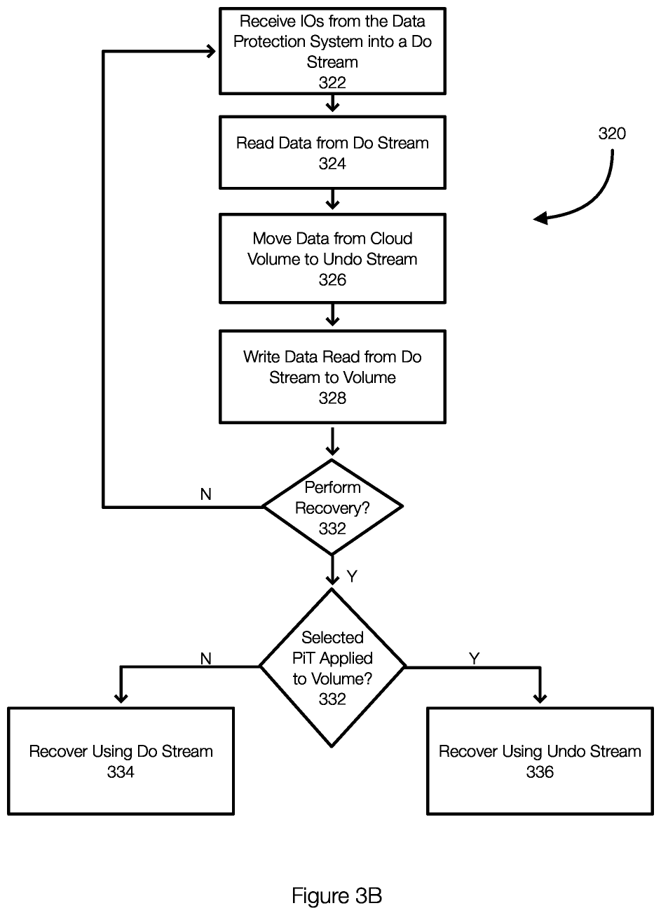

Embodiments of the invention are able to perform data protection operations at different levels. FIGS. 3A and 3B, for example, illustrate aspects of providing any PiT with minimized or reduced RTO without using a cloud volume for a journal. FIG. 3A discloses aspects of performing a data protection operation such as a backup operation and a recovery operation. More specifically, FIG. 3A discloses aspects of generating any PiT backups with reduced RTO. The production system 100 may operate as discussed with respect to FIG. 1.

In this example, the cloud 300 is configured such that the cloud object storage includes a volume 306 that corresponds to the production volume 106. Initially, the volume 306 is created as an image of the production volume 106. The volume 306 may be created, depending on the cloud provider, on an appropriate volume such as an EBS volume.

The data protection system 108 sends all relevant IOs to a do stream 302 (e.g., a Pravega stream). Occasionally, (e.g., periodically, on command, or in response to an event such as amount of data in the do stream 302), a compute instance 304 may power on and read data or IOs from the do stream 302. Current data on the volume 306 (data to be replaced or overwritten by the data read from the do stream 302) is read and saved to the undo stream 308. The data read from the do stream 302 is then written to the volume 306.

During a recovery operation, the desired point in time may not be found on the volume 306. In other words, data corresponding to the desired point in time may still be in the do stream 302. Thus, the PiT is represented in the do stream 302 or the undo stream 308. More specifically, the volume 306 is at time T. If the restore time Tᵣ (or the time at which the volume is to be restored) is less than T, then the PiT is in the undo stream 308. If Tᵣ is greater than T, then the PiT is in the do stream 302.

When T is greater (later than) Tᵣ, all relevant IOs from the do stream 302 are applied to the volume 306 while saving undo data from the volume 306 in the undo stream 308. Once all of the do data from the do stream 302 has been applied to the volume 306, a snapshot may be taken (e.g., for undoing test IOs) and the volume 306 (or the snapshot) may be mounted to the relevant compute instance for testing. Protection operations can continue by saving IOs generated at the production system 100 and received from the data protection system 108 to the do stream 302.

If the desired PiT was already applied to the volume 306, the volume is rolled to the desired PiT by applying data from or based on the undo stream 308. In other words, some of the data currently on the volume 306 may be replaced with data corresponding to the desired point in time that has been preserved in the undo stream 308. Once the volume 306 is at the selected point in time, a snapshot of the volume 306 is performed and the process proceeds as previously described.

In one example, before data from the undo stream 308 is applied to the volume 306, data from the volume 306 is read and inserted back into the do stream 302. This data is typically inserted at the head of the do stream 302. The volume 306 can then be rolled back by applying the data from the undo stream 308. Later, the volume 306 can be rolled back to future PiTs. When rolling the volume 306 forward, the writes inserted into the do stream 302 are applied in an order to maintain consistency.

Data in the undo stream 308 may be retained for a designated retention period (e.g., 7 days, a month). The compute instance 304 may wake periodically to check timestamps in the undo stream 308 to determine when to remove IOs from the undo stream 308 to meet retention specifications.

FIG. 3B discloses aspects of a method for performing data protection operations. In FIG. 3B, IOs are received 320 at the cloud replica or target site. More specifically, the IOs are received into a do stream. Next, data from the do stream is read 324 by a compute instance in the cloud. This occurs occasionally as the compute instance powers on and reads data from the do stream. The amount of data read may vary. For example, the data may be read up to a marker or a consistency point. The amount of data read may be fixed or based on the size of the do stream.

Next, data from the cloud volume, which is the volume corresponding to a production volume, is moved 326 from the cloud volume to an undo stream. Moving the data on the cloud volume that is about to be overwritten or replaced by data from the do stream to the undo stream ensures that previous PiTs are available for recovery if necessary. More specifically, the do stream 302 is read, in one example, before moving data on the volume 306. The do stream 302 includes metadata that allows the size and location of writes to be determined. This information or metadata is used to move data of that size and location from the volume 306 to the undo stream 308. Thus, in one example, the do stream 302 is read initially in order to obtain the metadata so that undo data can be preserved. Both the do stream and the undo stream are managed such that PiT backups are available for recovery.

Next, data read from the do stream is written 328 to the cloud volume. This process can repeat as necessary or when the compute instance powers on.

A recovery operation may occur at any time. If a recovery operation is not being performed (N at 332), the process 300 repeats. In one example, the method 320 continues operation regardless of whether a recovery is being performed. However, during a recovery, new IOs are placed in the do stream and the process of writing to the cloud volume periodically may be impacted when a recovery operation is being performed.

If a recovery is being performed (Y at 332), a PiT is selected (e.g., automatically, via a user interface) and a determination is made regarding whether data corresponding to the selected PiT has been applied to the cloud volume or not. If the selected PiT has been applied to the cloud volume (Y at 332), recovery is performed 336 using the Undo stream. Thus, if the data corresponding to the PiT has been applied to the cloud volume (or volume group or other configuration), the PiT can be recovered using the cloud volume and the undo stream.

If the selected PiT has not been applied to the cloud volume, then data corresponding to the PiT is still in the Do stream. Thus, the recovery is performed 334 using the Do stream as previously described.

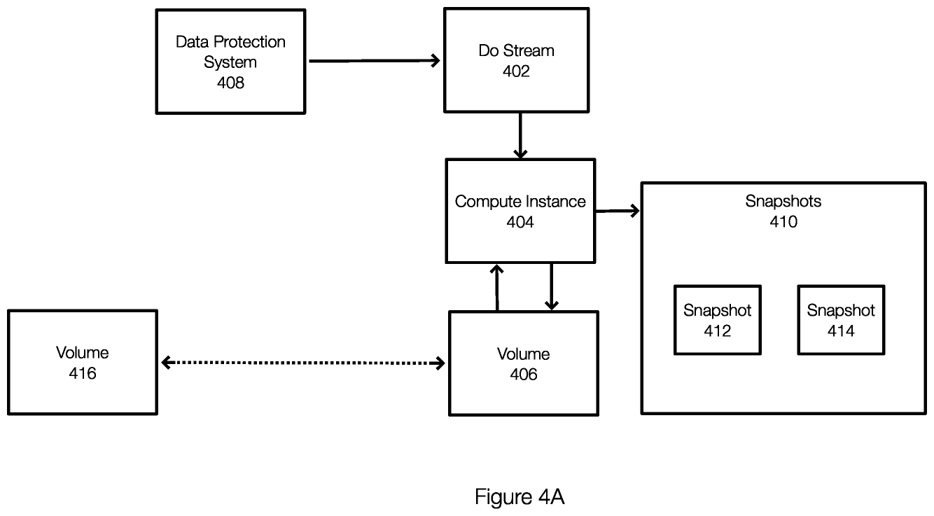

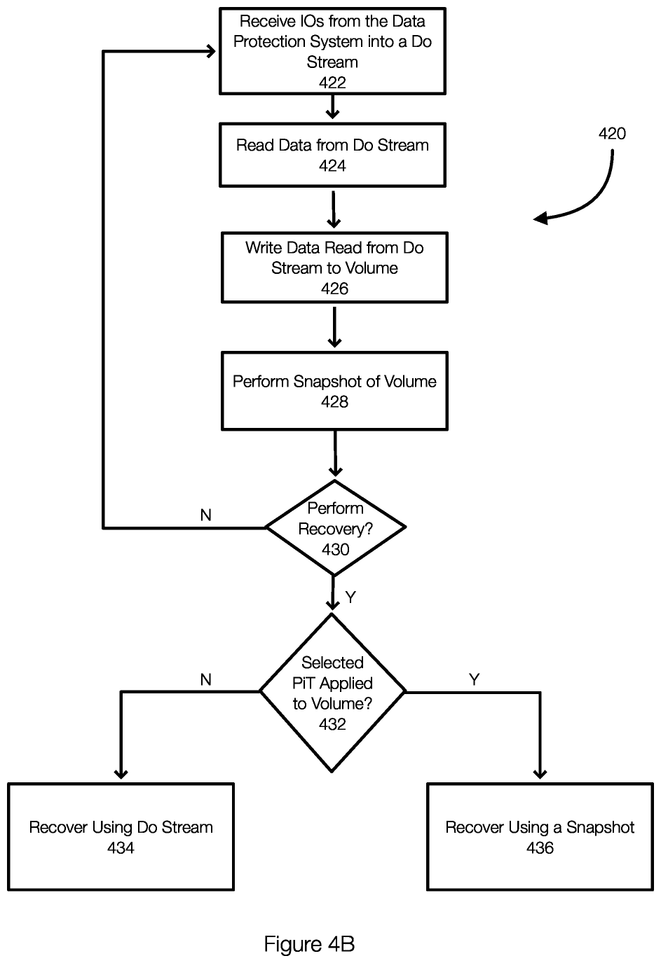

FIGS. 4A and 4B disclose aspects of data protection operations that may provide a discrete history with minimized or reduced RTO. FIG. 4A discloses aspects of performing data protection operations such as backup operations.

This embodiment, and in other embodiments, may include a cloud volume for each production volume or virtual disk. A stream may be provided for each volume or for each consistency group. Thus, production data is replicated to the relevant do stream.

FIG. 4A illustrates a data protection system 408, which may be an on-site or located on the production system side. The data protection system 408 may be configured to protect a consistency group (e.g., a group of volumes). In this example, the volume 406 is generated to correspond to a production volume 416. Writes to the volume 416 are replicated through the data protection engine 408 as previously described in some embodiments.

In FIG. 4A and after the volume 406 is initialized (is loaded with an image of the production volume 416), data protection may continue. In this example, the data protection system 408 sends all IOs that occur in the production system to the do stream 402. Occasionally, the compute instance 404 may power on or may instantiate. The compute instance 404 reads data from the do stream 402 up to a consistency point, for example, and applies the read data to the volume 406.

Next, a snapshot (e.g., the snapshot 412) is created from the volume 406. The snapshot 412 represents a PiT at a time of the consistency point. Over time, multiple snapshots 410 are generated (represented by the snapshots 412 and 414), each representing a consistency point.

When recovery is desired, the compute instance 404 may determine whether the desired PiT has been applied to the volume 406. If not, the compute instance 404 may apply data from the do stream 402 to reach the desired PiT. A snapshot is then performed for undoing test IOs. The volume is mounted to the relevant compute instance and tested. Protection continues by saving incoming data from the data protection system to the do stream 402.

If the desired PiT is represented by one of the snapshots 410, the server promotes this snapshot to a volume, mounts the volume to the relevant compute instance, and tests the mounted volume.

FIG. 4B discloses aspects of a method for performing data protection operations. In the method 420, IOs are received 422 from the data protection system into a do stream. Occasionally, a compute instance may instantiate and may read 424 data from the do stream. Data may be read up to a consistency point, for example, based on a marker or other indication of consistency. By occasionally instantiating the compute instance, costs of the compute instance are reduced compared to costs associated when using a journal for the Do data and the Undo data.

Next, the data read from the do stream is written 426 to the cloud volume. Thus, the cloud volume is in a consistent state. Once the data is written and the volume is in a consistent state, a snapshot is performed 428 and saved along with previous snapshots if any. Over time, multiple snapshots are generated. This creates a history of discrete snapshots from which recovery operations may be performed.

If a recovery operation is needed (Y as 430), a PiT is selected and a determination is made 432 regarding whether the PiT has been applied to the volume. If the selected PiT has not been applied to the volume (N at 432), then recovery is performed 434 using the do stream. More specifically, data from the do stream is read and written to the cloud volume such that the selected PiT can be recovered. Once the PiT is written to the cloud volume, a snapshot may be taken. Recovery is performed using this snapshot.

If the desired PiT has been applied to the volume (Y at (432), then the appropriate snapshot corresponding to the desired PiT (if available) is promoted 436 to the volume. The volume is mounted to a compute instance and is ready for testing and recovery. More specifically, the desired PiT is one of the previously created snapshots. The snapshot is recovered by promoting the snapshot to the cloud volume.

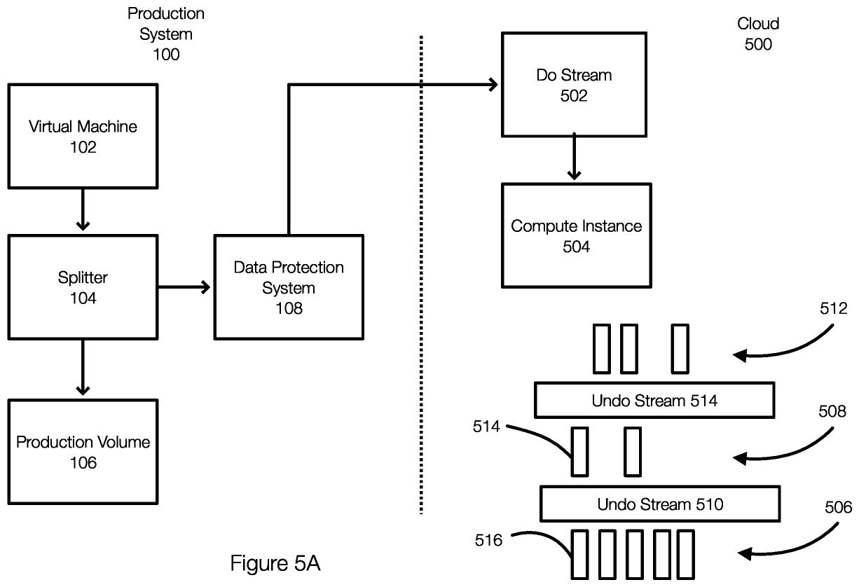

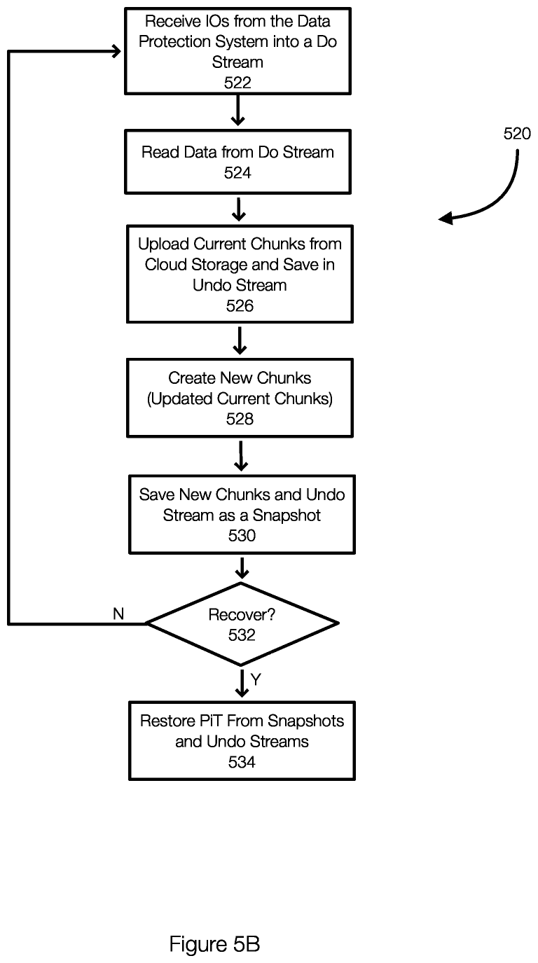

FIGS. 5A and 5B discloses aspects of data protection operations to reduce or minimize cost. In this example, only a stream is used for the Do data. FIG. 5A illustrates another embodiment for performing data protection operations including generating PiT backups and associated recovery operations. In FIG. 5A, the production system 100 operates as previously described.

As illustrated in FIG. 5A, data is stored as chunks to the cloud object storage. In one example, the chunks represent areas of a volume and are stored as separate objects in a cloud based object storage or other key/value storage.

During operation of the data protection system 108, a full image of a production volume is stored directly to cloud object storage in chunks, as illustrated by chunks 506. After the image has been uploaded (or during this initialization process), the data protection system 108 replicates or copies the IOs to the production volume 106 to a do stream 502.

A compute instance 504, on occasion (e.g., on command, periodically, trigger, event), powers on and reads the do stream 502 up to a certain point (e.g., a consistency point, which may be marked in the do stream). Once the data has been read, the compute instance 504 uploads chunks from cloud object storage corresponding to the data read from the do stream and creates updated chunks. The compute instance 504 can determine which chunks are impacted by the data in the do stream 502. Thus, the chunks are updated and committed back to the chunk storage.

In this manner, the new chunks (or IOs) from the do stream 502 are written to cloud object storage as chunks 508 along with an undo stream 510, which contains the overwritten data that was uploaded or read prior to writing the new chunks. For example, the do stream 502 may include data corresponding to the chunk 516. The chunk 516 is uploaded, updated with the new data, and written to storage as the new or updated chunk 514. Undo data is stored in the undo stream 510. With regard to the chunk 514/516, the undo stream 510 includes the data such that the chunk 514/516 can be recovered at any PiT between the snapshot 508 and the snapshot 506.

More generally, by way of example, the chunks 508 constitute a new snapshot. The undo stream 510 represents any PiT between the snapshot associated with the chunks 506 and the snapshot associated with the chunks 508.

At a later point in time, the compute instance may power on and read the do stream 502 up to a certain point. The compute instance then uploads the relevant chunks from cloud object storage, creates new chunks based on the do stream, and saves the new chunks 512 to cloud object storage as a new snapshot along with the undo stream 514. The undo stream 414 thus represents all PiT between the snapshot associated with the chunks 512 and the snapshot associated with the chunks 508.

FIG. 5B discloses aspects of a method for performing data protection operations. Initially, a fully image of a production volume is pushed to the cloud object storage in chunks. Thus, the method 520 operates on chunks.

Once initialized, IOs may be received 522 from the data the data protection system into a Do stream. Occasionally, a compute instance may start and read 524 data from the Do stream. Next, chunks are uploaded 526 from the cloud object storage. In one example, the chunks uploaded correspond to the chunks impacted by the IOs in the Do stream. The uploaded chunks are saved in an Undo stream.

Next, the chunks are updated with the read data from the Do stream to create 528 new chunks. The new chunks are saved 530 as a new snapshot along with the undo stream. The undo stream represents any PiT between two snapshots saved in the cloud object storage. If a recovery operation is not being performed (N at 532), the process 520 repeats. If a recovery operation is desired (Y at 532), the desired PiT is recovered or restored from the snapshots and the relevant undo streams. In one example or a recovery, the chunks are updated as necessary to correspond to the PiT. Thus, the desired PiT is restored 534 using the snapshots and the undo stream. The chunks can then mounted as a volume or in another appropriate manner.

In one example, a recovery or restore operation, when using chunks, includes unifying chunks from the snapshots and or the relevant undo streams in order to obtain an image to restore.

Embodiments of the invention thus constitute or provide any PiT protection using streams. Embodiments of the invention can adapt to production workloads without the need for additional automation.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations. Such operations may include, but are not limited to, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines, or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

It is noted with respect to the example method of Figure(s) XX that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, a for example, the various processes that may make up a method may be linked together or otherwise associated with each other by way of relations such as the examples just noted.

Following are some further example embodiments of the invention. These are presented only by way of example and are not intended to limit the scope of the invention in any way.

Embodiment 1. A method comprising: receiving writes from a data protection system configured to provide data protection operations to a production site into a do stream in the cloud, the writes including data, instantiating a compute instance to read data from the do stream, writing the data read from the do stream to the cloud volume by the compute instance, and performing a snapshot of the cloud volume.

Embodiment 2. The method of embodiment 1, wherein the do stream comprises a queue.

Embodiment 3. The method of embodiment 1 and/or 2, further comprising storing a plurality of snapshots, each corresponding to a different PiT.

Embodiment 4. The method of embodiment 1, 2, and/or 3, further comprising instantiating a recovery operation for PiT.

Embodiment 5. The method of embodiment 1, 2, 3, and/or 4, further comprising determining whether the selected PiT has been applied to the cloud volume.

Embodiment 6. The method of embodiment 1, 2, 3, 4, and/or 5, further comprising, when the selected PiT backup has been applied to the cloud volume, recovering the selected PiT backup using a snapshot from the plurality of snapshots that corresponds to the selected PiT.

Embodiment 7. The method of embodiment 1, 2, 3, 4, 5, and/or 6, further comprising promoting the snapshot that corresponds to the selected PiT to the cloud volume.

Embodiment 8. The method of embodiment 1, 2, 3, 4, 5, 6, and/or 7, further comprising, when the selected PiT has not been applied to the cloud volume, reading data from the do stream and applying the data read from the do stream to the cloud volume.

Embodiment 9. The method of embodiment 1, 2, 3, 4, 5, 6, 7, and/or 8, further comprising taking a snapshot of the cloud volume after applying the data from the cloud stream.

Embodiment 10. The method of embodiment 1, 2, 3, 4, 5, 6, 7, 8, and/or 9, further comprising continuing to receive new writes into the do stream while performing the recovery operation.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, by the Figures and/or elsewhere herein, may take the form of, or include, or be implemented on, or hosted by, a physical computing device. As well, where any of the aforementioned elements comprise or consist of a virtual machine (VM), that VM may constitute a virtualization of any combination of the physical components disclosed in the Figures or elsewhere herein.

In one example, the physical computing device includes a memory which may include one, some, or all, of random access memory (RAM), non-volatile memory (NVM) such as NVRAM for example, read-only memory (ROM), and persistent memory, one or more hardware processors, non-transitory storage media, UI device, and data storage. One or more of the memory components of the physical computing device may take the form of solid state device (SSD) storage. As well, one or more applications may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
receiving writes from a data protection system configured to provide data protection operations to a production site into a do stream in a cloud, the writes including data;
instantiating a compute instance to read data from the do stream;
writing the data read from the do stream to a cloud volume by the compute instance; and
performing a snapshot of the cloud volume, wherein the snapshot represents a PiT at a time corresponding to a consistency point.

2. The method of claim 1, wherein the do stream comprises a queue.

3. The method of claim 1, further comprising storing a plurality of snapshots, each corresponding to a different PiT.

4. The method of claim 3, further comprising instantiating a recovery operation for PiT.

5. The method of claim 4, further comprising determining whether a selected PiT backup from the plurality of snapshots has been applied to the cloud volume.

6. The method of claim 5, further comprising, in response to the selected PiT backup being applied to the cloud volume, recovering the selected PiT backup using a snapshot from the plurality of snapshots that corresponds to the selected PiT.

7. The method of claim 6, further comprising promoting the snapshot that corresponds to the selected PiT backup to the cloud volume.

8. The method of claim 5, further comprising, in response to the selected PiT backup not being applied to the cloud volume, reading data from the do stream and applying the data read from the do stream to the cloud volume.

9. The method of claim 8, further comprising taking a snapshot of the cloud volume after applying the data from the cloud stream.

10. The method of claim 4, further comprising continuing to receive new writes into the do stream while performing the recovery operation.

11. A non-transitory storage medium having stored therein instructions that are executable by one or more hardware processors to perform operations comprising:
receiving writes from a data protection system configured to provide data protection operations to a production site into a do stream in a cloud, the writes including data;
instantiating a compute instance to read data from the do stream;
writing the data read from the do stream to a cloud volume by the compute instance; and
performing a snapshot of the cloud volume, wherein the snapshot represents a PiT at a time corresponding to a consistency point.

12. The non-transitory storage medium of claim 11, wherein the do stream comprises a queue.

13. The non-transitory storage medium of claim 11, further comprising storing a plurality of snapshots, each corresponding to a different PiT.

14. The non-transitory storage medium of claim 13, further comprising instantiating a recovery operation for PiT.

15. The non-transitory storage medium of claim 14, further comprising determining whether a selected PiT backup from the plurality of snapshots has been applied to the cloud volume.

16. The non-transitory storage medium of claim 15, further comprising, when the selected PiT backup has been applied to the cloud volume, recovering the selected PiT backup using a snapshot from the plurality of snapshots that corresponds to the selected PiT.

17. The non-transitory storage medium of claim 16, further comprising promoting the snapshot that corresponds to the selected PiT to the cloud volume.

18. The non-transitory storage medium of claim 15, further comprising, when the selected PiT backup has not been applied to the cloud volume, reading data from the do stream and applying the data read from the do stream to the cloud volume.

19. The non-transitory storage medium of claim 18, further comprising taking a snapshot of the cloud volume after applying the data from the cloud stream.

20. The non-transitory storage medium of claim 11, further comprising continuing to receive new writes into the do stream while performing a recovery operation.
